(19) United States
(12) Patent Application Publication
(10) Pub. No.: US 2013/0274422 A1
(43) Pub. Date: Oct. 17, 2013

(54) POLYCARBONATES AS NUCLEATING AGENTS FOR POLYLACTIDES

(71) Applicants: Jean-François Carpentier, Acigne (FR); Sophie Guillaume, Vitre (FR); Marion Helou, Ixelles (BE); Martine Slawinski, Nivelles (BE); William Guerin, Rennes (FR)

(72) Inventors: Jean-François Carpentier, Acigne (FR); Sophie Guillaume, Vitre (FR); Marion Helou, Ixelles (BE); Martine Slawinski, Nivelles (BE); William Guerin, Rennes (FR)

(73) Assignees: CENTRE NATIONAL DE LA RECHERCHE SCIENTIFIQUE (CNRS), Paris (FR); TOTAL RESEARCH & TECHNOLOGY FELUY, Seneffe (BE)

(21) Appl. No.: 13/878,272

(22) PCT Filed: Oct. 5, 2011
(86) PCT No.: PCT/EP2011/067355

§ 371 Date: Jun. 21, 2013

(30) Foreign Application Priority Data
Oct. 13, 2010 (EP) 10290553.6

(51) Int. Cl. C08G 64/42

(52) U.S. Cl. CPC C08G 64/42
USPC 525/410

(57) ABSTRACT

The present invention discloses the use of polycarbonate to increase the crystallisation rate of polylactides while maintaining its the mechanical properties.

### FIELD OF THE INVENTION

The present invention relates to the preparation of polylactides wherein the nucleation is carried out by polycarbonates blocks and thus does not require the addition of other nucleating agents.

### BRIEF DESCRIPTION OF THE RELATED ART

Poly(L-lactide) (PLLA) is by far the most studied polymer. It is derived from 100% renewable resources such as corn, grain and beets. It is completely biodegradable and biocompatible and offers mechanical properties close to those of polystyrene.

Pure PLLA is slow to crystallise and nucleating agents are required in order to make use of industrially relevant processing techniques. As a consequence, there is a major interest in finding suitable additives that are effective in increasing the crystallite number density thereby resulting in an increase in the overall crystallisation rate. Common PLLA nucleating agents such as talc and clay increase the rate of crystallisation, but reduce the toughness in some systems.

The inherent brittleness nature of PLLA has been a major bottleneck for its large-scale commercial applications. Numerous approaches such as plasticisation block copolymerisation, blending with tough polymers, and rubber toughening have been adopted to improve the toughness of brittle polylactide bioplastic. The major drawbacks of these methods are a substantial decrease in both the strength and modulus of the toughened polylactide. So, a polylactide-based material having good stiffness-toughness balance along with high bio-based polylactide content is very desirable as discussed by K. Madhavan Nampoothiri, Nimisha Rajendran Nair and Rojan Pappy John (Bioresource Technology, 2010 101, 8493-8501) or by R. M. Rasal, A. V. Janorka, D. E. Hirt in Prog. Polym. Sci. 2010, 35, 338-356. or by Anders Södergård, Mikael Stolt in Prog. Polym. Sci. 2002, 27, 1123 or by A. Södergard, M. Stolt in Prog. Polym. Sci. 2002, 27, 1123-1163.

Adding nucleating agents to PLLA is required in order to modify its thermal and mechanical properties, especially to elevate its crystallinity; this is crucial for producing PLLA materials with high thermal stability and mechanical performance in limited processing time as discussed by Kolstadt (Kolstadt J. J. in J. Appl. Polym. Sci., 1996, 62, 1079-1091). Enhancement of the nucleation of PLLA crystallisation is thus sought upon addition of additives that act as nucleating agents, especially biodegradable nucleating agents, when used for environmental applications.

Most of the nucleating agents reported for PLLA were inorganic materials such as talc, montmorillonite or fullerenes as disclosed for example by Tsuji et al. (H. Tsuji, Y. Kawashima, H. Takikawa, J. Polym. Sci., Part B: Polym. Phys. 2007, 45, 2167; or H. Tsuji, H. Takai, N. Fukuda, H. Takikawa, Macromol. Mater. Eng. 2006, 291, 325). They were non-biodegradable as opposed to organic polymers, especially stereocomplexes formed upon addition of PDLA to PLLA.

Common PLLA nucleating agents such as talc as disclosed by Urayama et al. (Hiroshi Urayama, T. Kanamori, Kazuki Fukushima, Yoshiharu Kimura, in Polymer, 2003, 44, 5635-5641), or starch disclosed by kang et al. (Kyung Su Kang, Sang II Lee, Tae Jin Lee, Ramani Narayan and Boo Young Shin, Kor. J. Chem. Eng. 2008, 25, 599-608) or clay (R. Liao, B. Yang, W. Yu, C. Zhou, in J. Appl. Polym. Sci. 2007, 104, 310-317; Nobuo Ogata, Guillermo Jimenez, Hidekazu Kawai, and Takashi Ogihara, in J. Polym. Sci.: B: Polym. Phys., 1997. 35, 389-396) allowed increasing the rate of crystallisation, but some systems showed reduced toughness. The effect of additives in accelerating the overall PLLA crystallisation during cooling from the melt decreased in the following order: PDLA>talc>C60>montmorillonite>polysaccharides.

Many attempts to improve the ductility of PLLA were carried out by introducing a rubbery/elastomeric phase. The said phase, characterised by a low glass transition temperature and a low modulus, could be selected from plasticisers, blends and block copolymers. Efficient toughening of PLLA without detrimental effect on the mechanical performances should be best achieved with minimal amount of nucleating agent. Block copolymers containing PLA for modified mechanical behaviour reported in the literature most typically feature a linear architecture with less than about 50 wt-% PLA. In the few reported cases of PLA block copolymers containing predominantly PLA, compositions of greater than 90 wt % PLA have rarely been explored.

A great number of publications describe the use of PLA and especially of PDLA/PLLA stereocomplexes as nucleating agent for PLLA as reviewed for example by Tsuji, Hideto; Ikada, Yoshito. (Department of Ecological Engineering, Faculty of Engineering, Toyohashi University of Technology, Tempaku-cho, Toyohashi, Aichi, Japan. Editor(s): Yu, Long. Biodegradable Polymer Blends and Composites from Renewable Resources (2009), 165-190. Publisher: John Wiley & Sons, Inc., Hoboken, N. J). or by Galeski, A.; Piorkowska, E.; Pluta, M.; Kuklinski, Z.; Masirek, R. (Polimery 2005, 50, 562-569). Stereocomplexation enhances the mechanical properties and the thermal-resistance of PLLA-based materials as described in H. Tsuji (H. Tsuji Macromol. Biosci. 2005, 5, 569-597).

For instance, Tollman and Hillmyer (C. L. Wanamake, W. B. Tolman, M. A. Hillmyer Macromol. Symp. 2009, 283-284, 1360-138) have demonstrated the feasibility of using PDLA block copolymers at low levels as effective nucleating agents. Indeed, PDLA-PM-PDLA triblock copolymers, wherein PM is poly(menthide), acted as efficient nucleating agents for the crystallisation of PLLA at content ranging between 0.5 and 15 wt-% of the triblock copolymer in the PDLA-PM-PDLA/PLLA melt blends. PDLA-PM-PDLA triblock copolymers with PLLA formed triblock copolymer micelles in which the PDLA corona formed stereocomplexes with PLLA. Blends containing PDLA-PM-PDLA (15-31-15) stood out as having the highest nucleation efficiencies and the lowest crystallisation half-time values.

In 1995, Brochu et al. (Brochu, S.; Prud'homme, R. E.; Barakat, I.; Jérôme, R. in Macromolecules 1995, 28, 5230-5239) found that PLLA/PDLA stereocomplex crystallites could act as nucleating sites for the easier crystallisation of PLLA when the content of PDLA was as low as 10 wt-%. Similarly, Schmidt and Hillmyer (Schimdt, S. C.; Hillmyer, M. A. J. Polym. Sci, B: Polym. Phys. 2000, 39, 300-313) also observed a significant enhancement, as high as 150-fold increase in the number of nucleation sites, in the crystallisation rate of PLLA, following the addition of only 0.25 wt-% of PDLA. These authors further highlighted that the nucleation ability of the stereocomplex was most efficient when it was formed well before PLLA crystallisation. It was far superior to that of talc in its ability to enhance the rate of PLLA crystallisation. The addition of PDLA led to a reduction in the overall extent of PLLA crystallisation. In a related study, it was shown that nucleation efficiencies near 100% could be obtained with only 3 wt % of PDLA in a PLLA/PDLA stereocomplex, as reported by Anderson and Hillmyer (K. S. Anderson, M. A. Hillmyer in Polymer, 2006, 47, 2030-2035). The use of PDLA as nucleation sites, that is the improved crystallisation of PLLA with increasing PDLA content in the stereocomplex, was also reported by Yamane and Sasai (H. Yamane, K. Sasai, Polymer 2003, 44, 2569-2575) or by Tsuji et al. (H. Tsuji, H. Takai, S. K. Saha, Polymer 2006, 47, 3826). Other (co)polymers used in the nucleation enhancement of PLLA include poly(tetramethylene adipate-co-terephthalate) blend membranes as reported by Liua et al. (T.-Y. Liua, W.-C. Linb, M.-C. Yangb and S.-Y. Chen, Polymer, 2005, 46, 12586-1294), or hyperbranched poly(ester amide) as reported by Lin et al. (Y. Lin, K.-Y. Zhang, Z.-M. Dong, L.-S. Dong, and Y.-S. Li, Macromolecules 2007, 40, 6257-6267), or poly(butylene succinate) polymer blends are reported by Yokohara et al. (T. Yokohara, K. Okamoto, M. Yamaguchi, J. Appl. Polym. Sci. 2010, 117, 2226-2232).

Müller et al. (A. J. Müller, R. V. Castillo, M. Hillmyer, Macromol. Symp. 2006, 242, 174-181) showed that in diblock copolymers polylactide/polyethylene (PLLA-b-PE), the covalently bonded PE chains, that were molten down at the PLLA crystallisation temperature, slowed down the overall isothermal crystallisation rate of the PLLA block as compared to homo-PLLA. They attributed this change in crystallisation behaviour to a nucleation effect.

Hi. Tsuji, M. Sawada, and L. Bouapao reported in Appl. Mater. & Interf., 2009, 1, 1719 that three biodegradable polyesters, polyglycolide (PGA), poly(ε-caprolactone) (PCL) and poly[R-3-hydroxybutyrate] (PHB) accelerated the crystallisation of PLLA. The accelerated crystallisation of PLLA in the presence of these polyesters was attributable to a nucleation-assisting effect of PCL and PGA and a spherulite growth-accelerating effect of PHB, although the incorporated PHB lowered the spherulite number of PLLA per unit area.

Poly(glycolic acid) (PGA), a biodegradable aliphatic polyester, has been shown to act as a nucleating agent enhancing the overall crystallisation of PLLA during heating and cooling, even with PGA content as low as 0.1 wt %, as described by Tsuji et al. (H. Tsuji, K. Tashiro, L. Bouapao, J. Narita, Macromol. Mat. Eng., 2008, 293, 947-951). It has also been observed that PGA-co-PLA copolymers dyed with a low molecular weight organic molecule (D and C Violet No. 2,1-hydroxy-4-[(4-methylphenyl)-amino]-9,10-abthracenedione) used in surgical suture in an amount of 0.2 wt % had a faster crystallisation rate than the undyed copolymers.

Resilient bioresorbable copolymers based on TMC, LLA, and 1,5-dioxepan-2-one are reported by N. Andronova and A.-C. Albertsson in Biomacromolecules, 2006, 7, 1489-1495 based on tensile testing and cycling loading evaluation of the mechanical properties. The in vitro degradation of PTMC/PDLA copolymers as described by A. P. Pêgo, A. A. Poot, D. W. Grijpma, J. Feijen in Macromol. Biosci. 2002, 2, 411-419 was investigated through the evolution of their mechanical properties for PTMC contents not lower than 20 mol-%. Similarly, the same authors reported the mechanical and thermal properties changes obtained after water uptake by such high molecular weight TMC/D,LLA copolymers, which change from glassy to rubbery with 80 mol-% of DLA as reported by A. P. Pêgo, A. A. Poot, D. W. Grijpma and J. Feijen in J. Mater. Sci. Mater. Med., 2003, 14, 767-773. In a related study, Z. Zhang, D. W. Grijpma and J. Feijen described some creep-resistant porous structures based on stereocomplexes formed from PLLA and PDLA and PTMC. Effective rubber toughening of PLLA and LA stereocomplex has been achieved by block copolymerisation or blending with PTMC or PCL/PCL in 20 wt-% as reported by D. W. Grijpma, R. D. A. Van Hofslot, H. Supe\grave{r}, A. J. Nijenhuis and A. J. Pennings in Polym. Eng. & Sci. 1999, 34(22), 1674. Also, D. Pospiech, H. Komber, D. Jehnichen, L. Haussler, K. Eckstein, H. Scheibner, A. Janke, H. R. Kricheldorf, and O. Petermann reported in Biomacromolecules, 2005, 6, 439-446 thermal and mechanical data on PTMC/PLLA block copolymers without identifying any specific nucleation behaviour. Triblock copolymers based on TMC and LLA or DLA were shown by Z. Zhang, D. W. Grijpma and J. Feijen in Macromol. Chem. Phys. 2004, 205, 867-875 to behave as thermoplastic elastomers when PLA blocks were long enough. In blends of poly(LLA-TMC-LLA) and poly(DLA-TMC-DLA) triblock copolymers, stereocomplex formation between the enantiomeric PLA segments occurred as demonstrated by differential scanning calorimetry and light microscopy. These blends displayed good tensile properties and excellent resistance to creep under static and dynamic loading conditions. In a previous work Grijpma, D. W.; Joziasse, C. A. P.; Pennings, A. synthesised, a star-block copolymer of PTMC and PLA containing 6 wt % PTMC as reported in J. Makromol. Chem., Rapid Commun. 1993, 14, 155-161. However, the resulting material showed a 15% decrease in tensile yield strength and no increase in ductility when compared with PLA. Thermal and mechanical properties of PTMC/PLA copolymers were also reported by D. W. Grijpma and A. J. Pennings in Macromol. Chem. Phys. 1994, 195, 1633-1647 or in Macromol. Chem. Phys. 1994, 195, 1649-1663. However, no nucleation influence is clearly stated in any of these works.

Other papers report the mechanical properties of various polyesters/PLA without specifying a nucleation effect of the non-PLA block, as for instance in D. Cohn, A. F. Salomon, Biomaterials 2005, 26, 2297; C. L. Wanamaker, M. J. Bluemle, L. M. Pitet, L. E. O'Leary, W. B. Tolman, M. A. Hillmyer, Biomacromolecules 2009, 10, 2904; M. Ryner, A. C. Albertsson, Biomacromolecules 2002, 3, 601; S. Hiki, M. Miyamoto, Y. Kimura, Polymer 2000, 41, 7369; L. M. Pitet, M. A. Hillmyer, Macromolecules 2009, 42, 3674; E. M. Frick, A. S. Zalusky, and M. A. Hillmyer Biomacromolecules, 2003, 4, 216-223.

Therefore, reports of PLA block copolymers containing less than 10 wt-% rubbery additives that exhibit improved ductility relative to PLA homopolymer remain very rare.

The manufacture of lactic acid-based polymers by ring-opening polymerisation of lactides in the presence of various nucleating agents is also disclosed in JP-3350605 or in EP-A-1460107.

There is thus a need to replace the nucleating agent by compounds that are friendly to the environment, have good nucleating capabilities when present in a minor amount, while keeping a good balance of mechanical properties in the final polylactides.

### LIST OF FIGURES

FIG. 1 represents the differential scanning calorimetry (DSC) analysis of a PTMC-b-PLLA sample containing 5 wt-% of PTMC, based on the total weight of the sample and prepared by ring-opening copolymerisation. The solid line represents the first heating curve and the dashed line represents the second heating curve.

FIG. 2 represents the differential scanning calorimetry (DSC) analysis of a PTMC-b-PLLA sample containing 20 wt-% of PTMC, based on the total weight of the sample and prepared by ring-opening copolymerisation. The solid line represents the first heating curve and the dashed line represents the second heating curve.

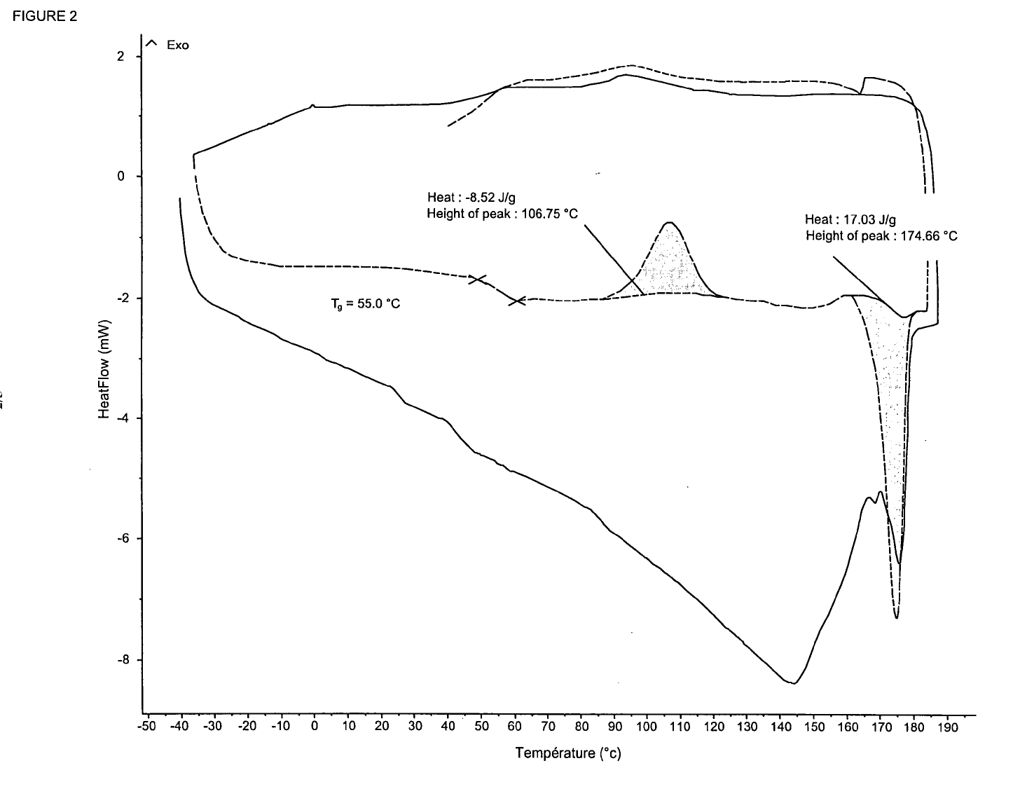

FIG. 3 represents the differential scanning calorimetry (DSC) analysis of a PLLA-b-PTMC-b-PLLA sample containing 20 wt-% of PTMC, based on the total weight of the sample and prepared by ring-opening copolymerisation. The solid line represents the first heating curve and the dashed line represents the second heating curve.

FIG. 4 represents the differential scanning calorimetry (DSC) analysis of a blend of homo-PLLA and homo-PTMC containing 20 wt-% of PTMC, based on the total weight of the blend. The solid line represents the first heating curve and the dashed line represents the second heating curve.

FIG. 5 represents the differential scanning calorimetry (DSC) analysis of a 50:50 wt-% blend of homo-PLLA having a number average molecular weight of 95 000 g/mol and PTMC-b-PLLA copolymer consisting of 5 wt-% of PTMC having a number average molecular weight of 2 360 g/mol and 95 wt-% of PLLA having a number average molecular weight of 40 700 g/mol. The solid line represents the first heating curve and the dashed line represents the second heating curve.

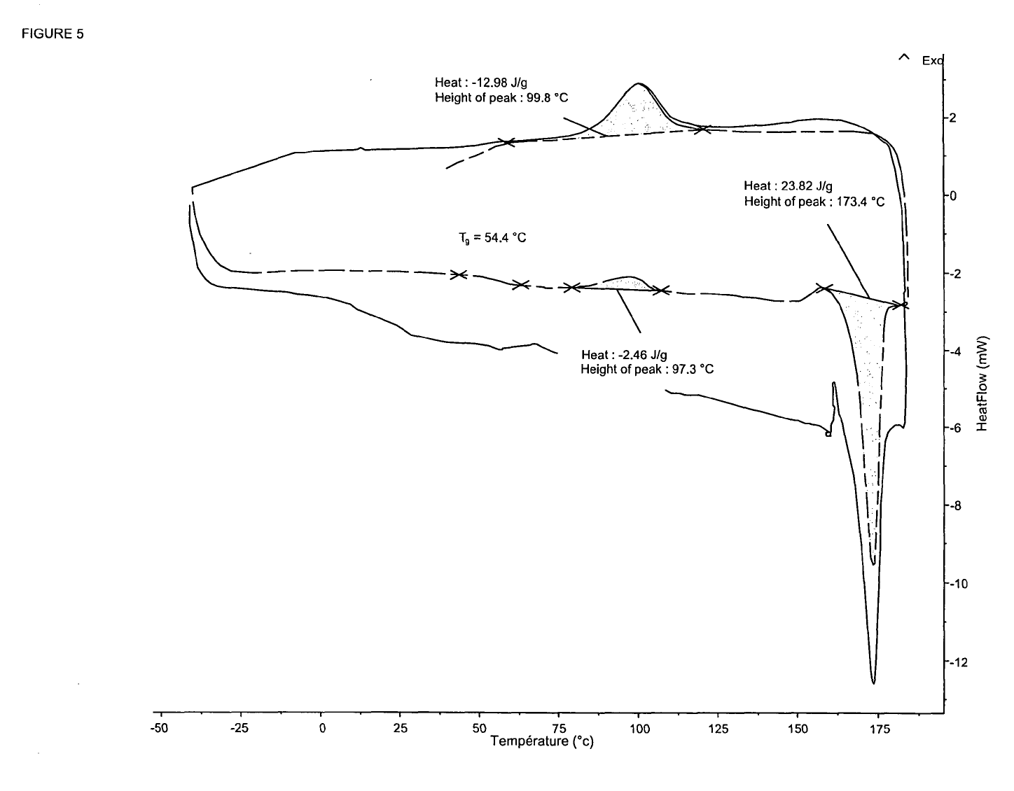

### SUMMARY OF THE INVENTION

It is an objective of the present invention to prepare block copolymers containing a semi-crystalline polylactide (PLLA) segment and an amorphous polycarbonate block.

It is another objective of the present invention to prepare biosourced block copolymers.

It is also an objective of the present invention to replace nucleating agents, necessary to the preparation of lactide-based plastics with optimised thermal and mechanical properties, by polylactide and/or polycarbonate block copolymers.

It is a further objective of the present invention to prepare polylactide/polycarbonate di- or multi-block copolymers having a good balance of thermal and mechanical properties.

In accordance with the present invention, the foregoing objectives are realised as described in the independent claims. Preferred embodiments are described in the dependent claims.

### DETAILED DESCRIPTION OF THE INVENTION

Accordingly, the present invention discloses a method for accelerating the crystallisation of polylactides (PLLA) by adding a polycarbonate (PC) block either as co-initiator and transfer agent in the copolymerisation of lactide and a cyclic carbonate, or in a blend polycarbonate/polylactide, and characterised in that nucleation of PLLA is favoured by the polycarbonate block.

The preferred lactide is L-lactide.

The percentage of polycarbonate in the di- or tri-block copolymer ranges between 1 and 30 wt-% based on the total weight of the polymer, preferably between 1 and 10 wt-% and more preferably between 1 and 7 wt-%.

In a first embodiment according to the present invention, the polylactide is prepared by any one of the methods known in the art, the polycarbonate is introduced under the form of a polylactide/polycarbonate block copolymer and the polylactide and block copolymer are blended. The amount of block copolymer ranges between 1 and 50 wt-%, based on the total weight of the blend, preferably between 1 and 8 wt-% and more preferably between 1 and 7 wt-%.

Addition of a polycarbonate homopolymer to a polylactide homopolymer does not seem to produce any nucleating effect.

In a preferred embodiment according to the present invention, the polycarbonate block is added in a ring-opening copolymerisation process between a lactide and a cyclic carbonate wherein the di-, tri, or multi-block polylactide/polycarbonate polymers are prepared by the steps of:
a) providing catalyst system based on a compound selected from a Lewis acidic metal salt or a metal complex or a metal-free organic base;
b) providing either a linear monohydroxy HO—PC—OR, or a linear dihydroxy-telechelic HO—PC—OH, or a star polyhydroxy R—(PC—OH)n end-capped polycarbonate acting both as co-initiator and as transfer agent via hydroxyl group(s), wherein PC is a polycarbonate chain obtained by immortal ring-opening polymerisation of a cyclic carbonate monomer;
c) providing a lactide monomer;
d) maintaining under polymerisation conditions at a temperature of from room temperature to 150° C. in bulk (melted monomer) or in a solvent;
e) retrieving a di- tri- or multi-block copolymer.

The immortal ring-opening polymerisation of cyclic carbonates in the presence of an organometallic catalyst complex and an alcohol has been disclosed for example in WO2009/106460.

It is known to prepare HO—PC—OR homopolymers in high yield by ring-opening polymerisation of cyclic carbonates in the presence of a catalyst system comprising an organometallic complex or a metallic salt or an organic compound and an alcohol or a polyol as described for example in WO2009/106460. These homopolymers have controlled molecular weight and narrow polydispersity wherein the polydispersity is described by the polydispersity index which is the ratio Mw/Mn of the weight average molecular weight Mw over the number average molecular weight Mn.

It is also known to prepare diblock copolymers polylactide/polycarbonate as disclosed in WO2010/066597, wherein after the homopolymerisation of the cyclic carbonate is completed, lactide is added to the reaction mixture and stirred during the time necessary to afford the desired diblock copolymer as exemplified in scheme 1.

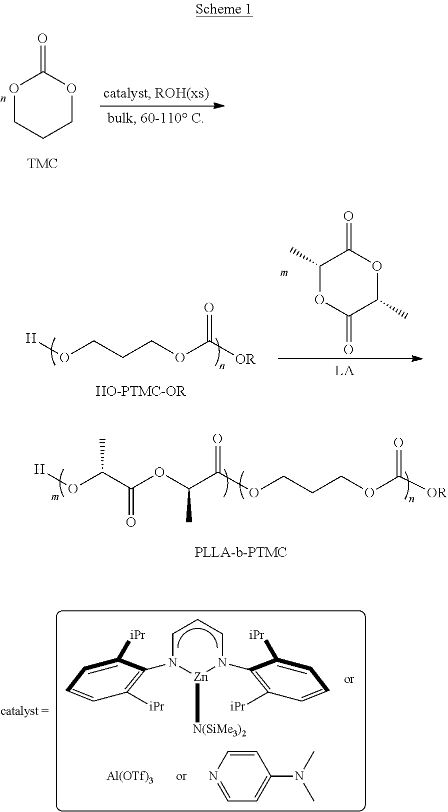

The cyclic carbonates are cyclic monomers potentially derived from the biomass that can be used to prepare the polycarbonate can be selected from any 5-, 6-, or 7-membered cyclic carbonates and preferably from the list below, which is just illustrative and in any case limitative:

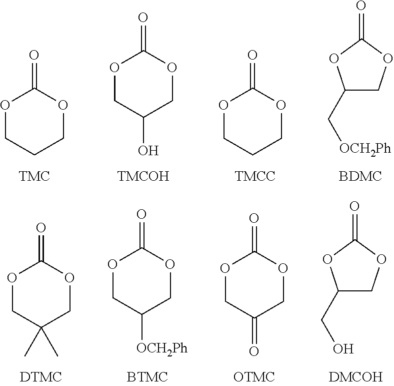

TMCOH, DMCOH are derived directly from glycerol. TMCC and BTMC derive from TMCOH and thus indirectly from glycerol.

More preferably, it is trimethylene carbonate (TMC).

The catalyst components that can be used to prepare the polycarbonate blocks have been described in detail for example in co-pending application WO2010/066597 and will be summarised here.

The metal complexes acting as catalyst systems can be selected from single-site catalyst components, for instance, based upon a bulky β-diiminate ligands (BDI) as described by Coates et al. (B. M. Chamberlain, M. Cheng, D. R. Moore, T. M. Ovitt, E. B. Lobkovsky, and G. W. Coates, in J. Am. Chem. Soc., 2001, 123, 3229) and represented for Zn by the general formula:

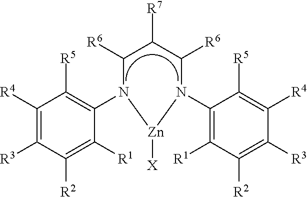

wherein R¹, R², R³, R⁴, R⁵, R⁶ and R⁷ are each independently selected from hydrogen, unsubstituted or substituted hydrocarbyl, or inert functional group and wherein two or more of said groups can be linked together to form one or more rings, wherein X is an hydrocarbyl radical having from 1 to 12 carbon atoms, an alkoxide group OR*, an amido group NR**₂ or a borohydride group (BH₄).

Among the preferred catalytic compounds of that category, one can further cite [BDI]Zn(N(SiMe₃)₂), {[BDI]Zn(OiPr)}₂, Zn(N(SiMe₃)₂), ZnEt₂, Ln(N(SiMe₃)₂)₃ (Ln=group III metals, including the lanthanide series), “Ln(OiPr)₃”, Al(OiPr)₃, Mg[N(SiMe₃)₂]₂, Ca[N(SiMe₃)₂]₂(THF)₂, (BDI)Fe[N(SiMe₃)₂], Fe[N(SiMe₃)₂]₂, and Fe[N(SiMe₃)₂]₃.

They act by a coordination/insertion mechanism.

The metallic salt can be selected from metallic complexes of formula M(OSO₂CF₃)ₙ, hereafter referred to as triflates or OTf, or of formula M(N(OSO₂CF₃)₂)ₙ, hereafter referred to as triflimidates or NTf₂, or of formula M(RC(O)CR₂C(O)R)ₙ, hereafter referred to as acetylacetonates or acac or of formula (R″CO₂)ₙM, hereafter referred to as carboxylates, wherein M is a metal Group 2, 3, including the lanthanide series, hereafter referred as Ln, 4, 12, 13, 14 or 15 of the periodic Table, wherein each R is selected independently from a linear or branched hydrocarbyl radical having from 1 to 12 carbon atoms, substituted or not by for instance an halogen or heteroatom, wherein each R″ is selected independently from a perfluorinated alkyl or aryl residue having from 1 to 12 carbon atoms, and wherein n is the valence of M.

Preferably, M is Mg(II), Ca(II), Sc(III), Ln(III), Y(III), Sm(III), Yb(III), Ti(IV), Zr(IV), Fe(II), Fe(III), Zn(II), AI(III) Sn(IV) or Bi(III). More preferably, it is Al, Bi, Zn or Sc. Most preferably, it is Al which is the most efficient metal.

Preferably each R is selected independently from alkyl group such as CH₃ or a substituted alkyl group such as CF₃. More preferably, they are all the same and they are CH₃ or CF₃.

Preferably, R″ is (C₆F₅) or (CF₃), or CF₃(CF₂)ₘ wherein m is an integer ranging between 1 and 6.

Among the preferred catalytic compounds in this category, one can cite as non limitative examples Al(OTf)₃, Al(NTf₂)₃, Mg(OTf)₂, Ca(OTf)₂, Zn(OTf)₂, Sc(OTf)₃, Bi(OTf)₃, Al(hfacac)₃ (hfacac=1,1,1,5,5,5-hexafluoroacetylacetonate), Fe(acac)₃, Al(OCOCF₃)₃, Zn(OCOCF₃)₂, Zn(BF₄)₂, Zn(acac)₂, Zn(hfacac)₂.

These catalysts act by an activated monomer pathway, in combination with an external nucleophile, that is the alcohol compound.

The non-metallic organic compounds can be selected, as non limitative examples, from dimeric phosphazene bases as disclosed for example in Zhang et al. (Zhang L., Nederberg F., Messman J. M., Pratt R. C., Hedrick J. L., and Wade C. G., in J. Am. Chem. Soc., 2007, 129, 12610-12611) or phosphazene bases as disclosed for example in Zhang et al. (Zhang L., Nederberg F., Pratt R. C., Waymouth R. M., Hedrick J. L., and Wade C. G., in Macromolecules 2007, 40, 4154-4158) or organic compounds such as amines or guanidine as described for example in Nederberg et al. (Nederberg F., Lohmeijer G. B., Leibfarth F., Pratt R. C., Choi J., Dove A. P., Waymouth R. M., Heidrich J. L., in Biomacromolecules, 2007, 8, 153) or in Mindemark et al. (Mindemark J., Hilborn J., Bowden T., in Macromolecules, 2007, 40, 3515).

The organocatalyst precursors are preferably selected from amines, guanidines (e.g., TBD, MTBD), amidines (e.g., DBU), tertiary amines (e.g., DMAE, DMAEB), some NHCs, bifunctional thiourea-tertiary amine catalysts or phosphazene (Scheme 2).

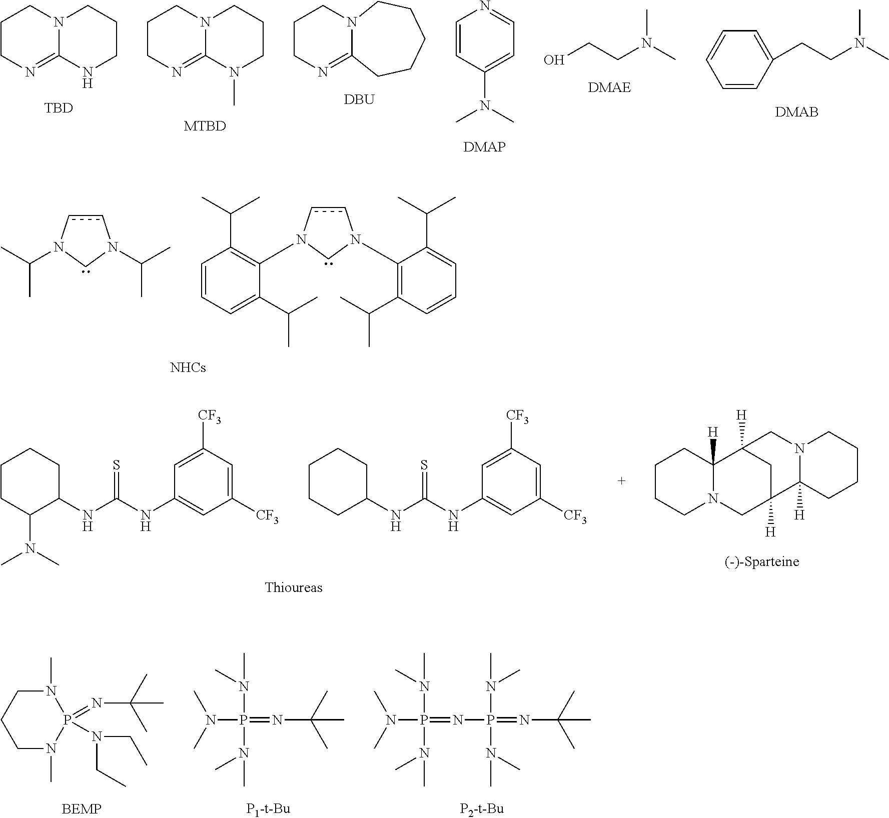

The preferred organocatalysts according to the present invention are selected from 4-dimethylaminopyridine (DMAP) or 1,5,7-triazobicyclo-[4,4,0]dec-5-ene (TBD) or tert-butylimino-1,3-dimethylperhydro-1,3,2-diazaphosphine (BEMP). More preferably, it is BEMP.

The catalyst system based on organocatalysts operates via a so-called “activated monomer pathway”.

All catalyst components are used in the presence of excess alcohol wherein the alcohol plays two roles:
as an external nucleophile for initiating the polymerisation via the ring-opening of the activated monomer; 1 equivalent of alcohol per organocatalyst is used in the process;
as a transfer agent, by generating multiple polymer chains; all excess alcohol molecules are used in this second process, and the final molecular weight of the polymer is a function of the alcohol-to-monomer ratio.

The alcohol can be represented by formula R′OH wherein R′ is a hydrocarbyl, linear or branched, having from 1 to 20 carbon atoms. Preferably R′ is a secondary alkyl residue or benzylic group, more preferably it is isopropyl (iPr) or benzyl (Bn). It can also be a poly-ol (diol, triol and higher functionality polyhydridic alcohols), typically 1,3-propanediol or trimethylolpropane, possibly derived from biomass such as glycerol or any other sugar-based alcohol (e.g., erythritol, cyclodextrine). Alternatively, the alcohol can be replaced by another protic source such as an amine that can be selected for example from C₆H₅CH₂NH₂ or C₃H₇NH₂.

All catalyst components and alcohols can be used individually or in combination.

The alcohol is used in excess with an alcohol to catalyst molar ratio of at least 5.

The polyesters obtained by the present method are characterised by excellent mechanical properties. The elastic modulus is not diminished, on the contrary it is slightly increased and the elongation at break remains unchanged.

The thermal properties of the polymer, studied by Differential Scanning Calorimetry (DSC) have revealed that a small polycarbonate segment present in the copolymer increases the crystallisation rate, thereby acting as a nucleating agent. The nucleating effect is maximum for an amount of polycarbonate ranging between 1 and 7 wt-% based on the total weight of the polymer.

### EXAMPLES

### Synthesis of PTMC-b-PLLA Copolymers

Diblock copolymers containing a semi-crystalline PLLA segment and an amorphous, low glass transition temperature PTMC block have been prepared according to scheme 1.

5 mg of (BDI)Zn(N(SiMe₃)₂) (7.77 μmol, 1 equiv.) were added to 4 μL of BnOH (0.039 mmol, 5 equiv.) placed in 0.1 mL of toluene and stirred over a period of time of 15 min just prior to the addition of 0.793 g of TMC (7.77 mmol, 1000 equiv.). The mixture was immediately stirred at the desired temperature for the appropriate reaction time typically of 10 min in order to allow complete TMC conversion. 1.12 g of L-LA (7.77 mmol, 1 000 equiv.) were then added to the flask. The polymerisation was allowed to proceed up to 100% conversion and then stopped upon addition of 1 mL of a 16.5×10⁻³ mol·L⁻¹ acetic acid solution in toluene. Drying of the resulting mixture followed by ¹H NMR analysis allowed the determination of the monomers conversion. After dissolution in CH₂Cl₂, precipitation in cold methanol, filtration and drying, the copolymer PTMC-b-PLLA was obtained.

The thermal properties of the purified polymers were evaluated by differential scanning calorimetry (DSC 131, Setaram instrument unless otherwise stated). Experiments were performed in aluminium pans with helium as gas purge. 6 to 12 mg copolymer samples were used for DSC analysis. Samples were heated from −40° C. to 200° C. with a heating rate of 10° C./min, cooled down to −40° C. with a cooling rate of 10° C./min (unless otherwise stated), and then heated again to 200° C. at the same heating rate.

Melting temperature (Tm), crystallisation temperature (Tc) and glass transition temperature (Tg) of each samples were obtained from the second heating curves. The weight percentage (wt-%) of PTMC in PTMC-b-PLLA diblocks was varied and its influence on the recrystallisation of PLLA can be seen in Table 1.

TABLE 1

| Polymers | | Thermal properties^{b} | | | | | | | |
|---|---|---|---|---|---|---|---|---|---|
| Mn^{a} | Mn^{a} | Tg | Tm | Tc_{heating} | Tc_{cooling} | ΔHc_{1st heating} | ΔHc_{2nd heating} | ΔHₘ | ΔHc_{cooling} |
| PLA | PTMC | (° C.) | (° C.) | (° C.) | (° C.) | (J/g) | (J/g) | (J/g) | (J/g) |
| 40 700 | 2 360 | 56 | 178 | 87 | 123 | −12.9 | — | 25.5 | −22.3 |
| (95%) | (5%) | | | | | | | | |
| 39 800 | 2 850 | 58 | 173 | 88 | 97 | — | — | −22.5 | −17.8 |
| (94%) | (6%) | | | | | | | | |
| (90%) | (10%) | 64 | 164 | — | 97 | — | — | 17.1 | −12.5 |
| 39 000 | 7 000 | 48 | 173 | 90 | 96.8 | — | — | 17.6 | −6.9 |
| (85%) | (15%) | | | | | | | | |
| 40 900 | 10 200 | 55 | 174 | 107 | — | — | −8.5 | 17.0 | — |
| (80%) | (20%) | | | | | | | | |

^{a}Determined by ¹H NMR
^{b}Determined by DSC; Tg refers to PLLA

The mechanical properties of the copolymers were evaluated using compression-moulded sheets. The copolymers were moulded by mini max moulder of custom scientific instruments Inc., at temperatures respectively of 180° C. for PLA and of 220° C. for PTMC.

Tensile tests were carried out on 6 samples of the same copolymer at room temperature according to the method of standard test ASTMD 882 by a ZWICK (MEC125/2) with load cell 200 N at a cross-head speed of 10 mm/min. Strength and elongation values at break were calculated based on the dynamic tensile diagrams. The sample specimen deformation was derived from the grip-to-grip separation, which was initially of 10 mm. The results are displayed in Table 2.

TABLE 2

| | Polymers | | | | | | | | |
|---|---|---|---|---|---|---|---|---|---|
| | Mn | Mn | Injection conditions | | Traction | | | | |
| | PLLA | PTMC | copo | Mould | Elastic | | | | |
| | g/mol | g/mol | temp | temp | modulus E | Yield | ε-F max | σ rupture | ε rupture |
| Ex | (wt %) | (wt %) | (° C.) | (° C.) | (Mpa) | (Mpa) | (Mpa) | (Mpa) | (%) |
| PLLA | 95 000 | — | 190 | 23 | 1 267 ± 24 | 69 ± 2 | 6.9 | 62 ± 2 | 7.4 ± 0.2 |
| | (100) | | | | | | | | |
| PTMC | — | 95 000 | 220 | 23 | 4.5 | 1.2 | 123 | 0.8 | 630 |
| | | (100) | | | | | | | |
| 1 | 40 700 | 2 360 | 190 | 23 | 1 359 ± 46 | 47 ± 5 | 4.2 ± 0.6 | 47 ± 5 | 4 ± 0.6 |
| | (95) | (5) | | | | | | | |
| 2 | 39 800 | 2 850 | 195 | 23 | 1 580 ± 62 | 62 ± 5 | 5 ± 0.2 | 54 ± 4 | 6 ± 0.7 |
| | (94) | (6) | | | | | | | |
| 3 | 39 000 | 7 000 | 190 | 23 | 1 420 ± 55 | 23 ± 5 | 1.7 ± 0.4 | 23 ± 5 | 2 ± 0.4 |
| | (85) | (15) | | | | | | | |
| 4 | 40 900 | 10 200 | 195 | 23 | 985 ± 12 | 46 ± 3 | 6 | 34 ± 3 | 178 ± 16 |
| | (80) | (20) | | | | | | | |

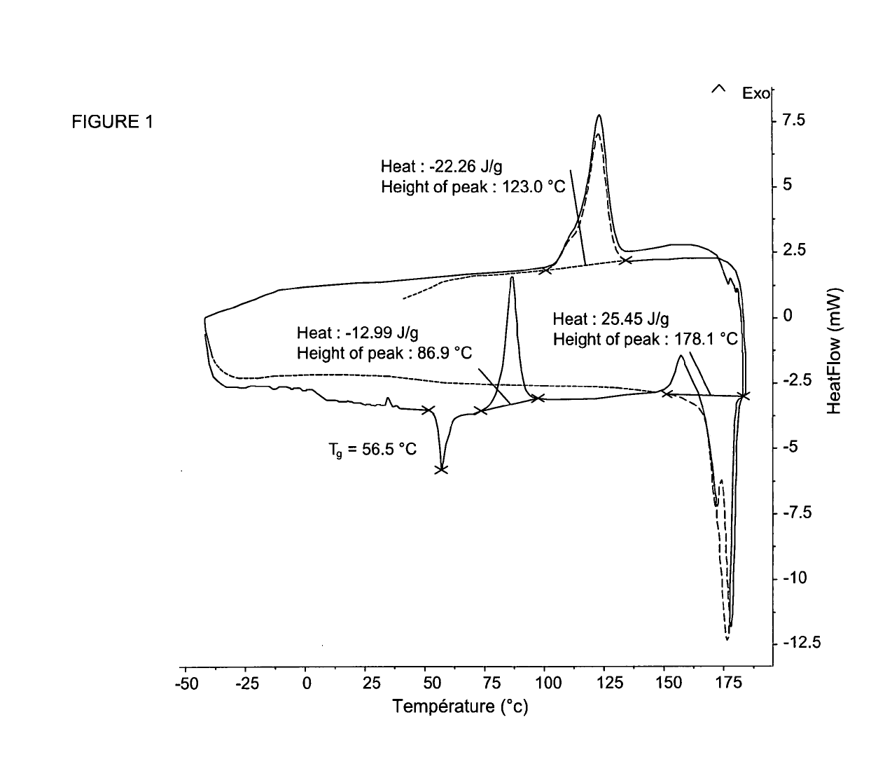

It can be seen from Table 2 that the incorporation of 5 or 6 wt-% of PTMC having a molecular weight inferior to 3 000 g/mol in PLLA having a molecular weight of the order of 40 000 g/mol slightly increased the elastic modulus while keeping the elongation at break unchanged. At the same time, the thermal properties of example 1, obtained by DSC, are presented in FIG. 1. The first heating curve represented by the solid line shows the glass transition temperature of PLLA at 56° C., the exothermal crystallisation peak and the melting temperature at 175° C. During the cooling cycle, a new peak appeared at a temperature of 104° C. corresponding to the re-crystallisation of the polymer. On the second heating curve represented by a dashed line, the crystallisation peak preceding the melting temperature disappeared, thereby showing that the small PTMC segment present in the copolymer had accelerated the crystallisation of PLLA, thereby acting as nucleating agent.

It can be concluded that an amount of polycarbonate ranging between 1 and 7 wt-%, based on the total weight of the polymer offers the best nucleating power while maintaining the mechanical properties of PLLA.

Similar results have been observed for triblock and star-shaped copolymers. Triblock copolymers PLLA-PTMC-PLLA can be prepared according to scheme 2.

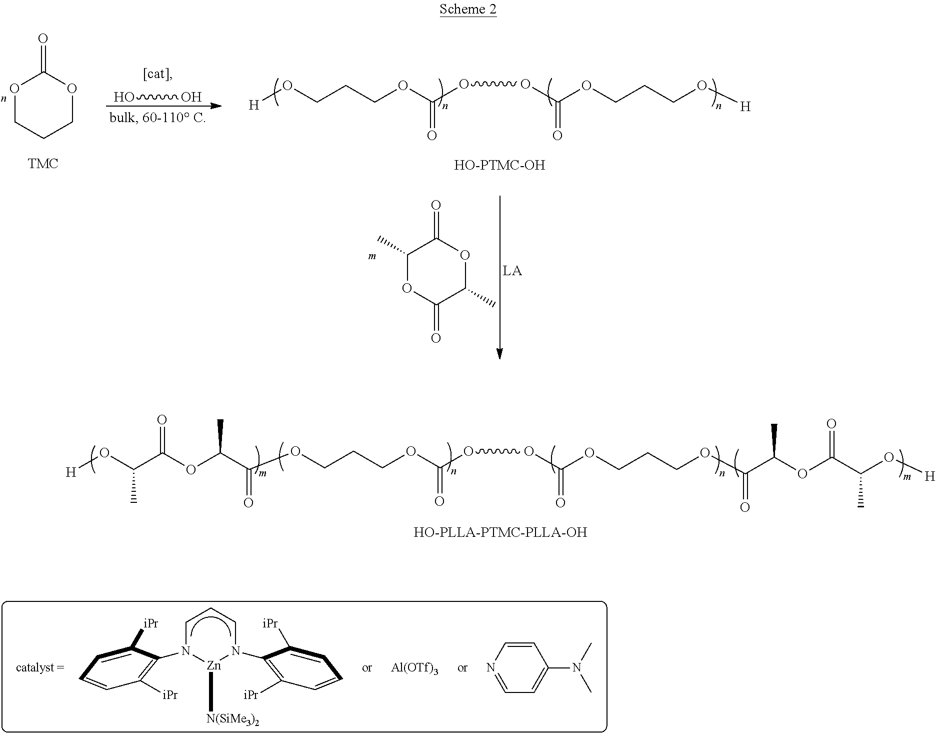

The results are displayed in Table 3.

TABLE 3

| | Mₙ (g · mol⁻¹) | Mₙ (g · mol⁻¹) | | | | | Nucleating |
|---|---|---|---|---|---|---|---|
| | PLLA^{a} | PTMC^{a} | T_{g} (° C.) | T_{g} (° C.) | T_{c} (° C.) | Tₘ(° C.) | effect |
| Ex | (wt %) | (wt %) | PTMC^{b} | PLLA^{b} | PLLA^{b} | PLLA^{b} | observed |
| 1 | (95) | (5) | | | | | |
| 2 | (90) | (10) | | | | | |
| 3 | (85) | (15) | | | | | |
| 4 | 38 000 | 9 500 | — | 48 | 90 | 172 | Partially |
| | (80) | (20) | | | | | |

^{a}Determined by ¹H NMR
^{b}Determined by DSC

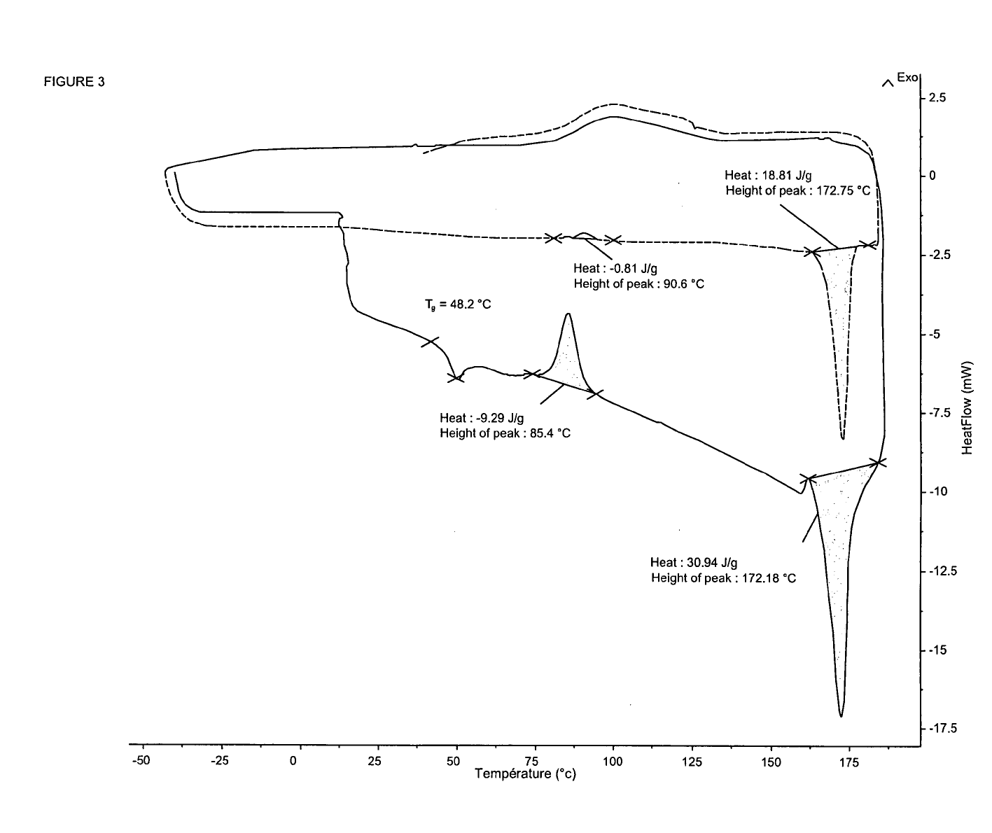

Consistent with the results obtained for diblock PLLA-b-PTMC, DSC analysis carried out on triblock PLLA-b-PTMC-b-PLLA containing 20 wt-% of PTMC having a number average molecular weight of 9 500 g/mol, showed that the recrystallisation of PLLA was almost complete as seen in FIG. 3.

The results are displayed in Table 4.

TABLE 4

| polymers | | | | | | | | |
|---|---|---|---|---|---|---|---|---|
| Mn | Mn | Injection | | Traction | | | | |
| PLA | PTMC | conditions | | | | ε- | σ- | ε- |
| g/mol | g/mol | Tₘₐₜ | T_{mould} | E | Yield | Fₘₐₓ | break | break |
| (%) | (%) | ° C. | ° C. | Mpa | Mpa | % | Mpa | % |
| 38800 | 9500 | 185 | 23 | 1275 | 55 | 5.8 | 26 | 262 |
| (80) | (20) | | | | | | | |

### Preparation of PTMC/PLLA Blends

In a typical experiment, 10 mg of PTMC (1.5 μmol) having a number average molecular weight Mₙ of 6 650 g·mol⁻¹ and 90 mg of PLLA (0.95 μmol) having a number average molecular weight Mₙ of 95 000 g·mol⁻¹) were stirred at room temperature in 10 mL of dichloromethane until complete dissolution. The solvent was then removed in vacuum. The final blend was analysed by DSC (10-15 mg).

Blends of homopolycarbonate and homopolylactides were prepared according to the above procedure, with polycarbonate content ranging between 5 and 15 wt-% based on the total weight of the blend. The results of DSC analyses are displayed in Table 5.

TABLE 5

| | Mₙ (g · mol⁻¹) | Mₙ (g · mol⁻¹) | | | | | Nucleating |
|---|---|---|---|---|---|---|---|
| | PLLA^{a} | PTMC^{a} | T_{g} (° C.) | T_{g} (° C.) | T_{c} (° C.) | Tₘ(° C.) | effect |
| Entry | (wt %) | (wt %) | PTMC^{b} | PLLA^{b} | PLLA^{b} | PLLA^{b} | observed |
| 1 | 95 000 | 6 650 | — | 62 | 105 | 170 | None |
| | (95) | (5) | | | | | |
| 2 | 95 000 | 6 650 | — | 62 | 104 | 170 | None |
| | (90) | (10) | | | | | |
| 3 | 95 000 | 6 650 | −16 | 60 | 102 | 170 | None |
| | (80) | (20) | | | | | |

^{a}Determined by ¹H NMR
^{b}Determined by DSC

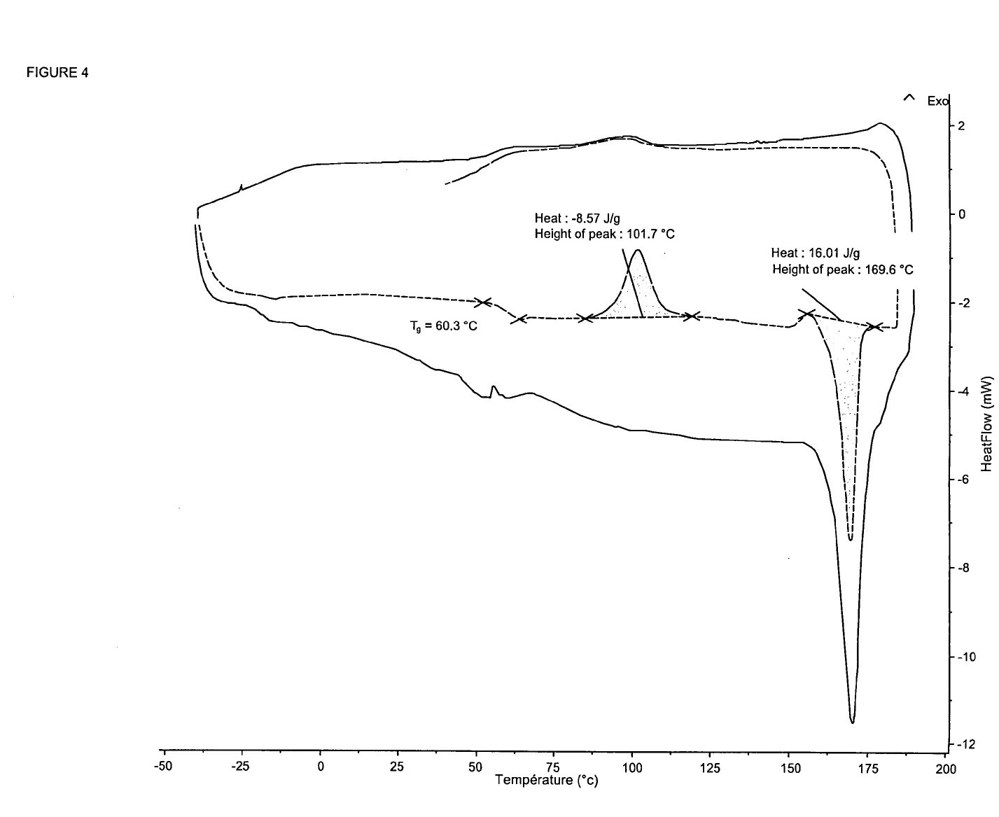

As can be seen from Table 5, the addition of up to 20 wt-% of PTMC having a number average molecular weight Mn of 6 650 g/mol in a PLLA block having a number average molecular weight Mn of 95 000 g/mol did not increase the crystallisation rate of PLLA. More, DSC analysis, represented in FIG. 4, did not show any nucleation effect on the samples examined.

### Preparation of PTMC-b-PLLA/PLLA Blends

Several blends of a PTMC-b-PLLA copolymer and homoPLLA were prepared with various amounts of PTMC-b-PLLA in the blends and various compositions (with different wt-%) of the PTMC-b-PLLA copolymers. The results for several blends are displayed in Table 6.

TABLE 6

| | | | Thermal properties | | | | | | | |
|---|---|---|---|---|---|---|---|---|---|---|
| | Polymers | | Tg | Tm | Tc_{heating} | Tc_{cooling} | ΔHc_{1st heating} | ΔHc_{2nd heating} | ΔHₘ | ΔHc_{cooling} |
| | Mn PLA | Mn PTMC | (° C.) | (° C.) | (° C.) | (° C.) | (J/g) | (J/g) | (J/g) | (J/g) |
| HomoPLLA | 95 000 | — | 63 | 172 | 116 | — | −16.9 | −20.2 | 20.9 | — |
| Ex 1 (diblock) | 40 700 | 2 360 | 56 | 178 | 87 | 123 | −12.9 | — | 25.1 | −22.3 |
| | (95%) | (5%) | | | | | | | | |
| Ex 2 (diblock) | 40 900 | 10 200 | 55 | 174 | 107 | — | — | −8.5 | 17.0 | — |
| | (80%) | (20%) | | | | | | | | |

| | | | | | | | | | |
|---|---|---|---|---|---|---|---|---|---|
| Ex 3 (blend) | 50% diblock Ex 1 | 54 | 173 | 97 | 100 | — | −2.5 | 23.8 | −12.9 |
| | 50% HomoPLLA | | | | | | (16%) | | (84%) |
| Ex 4 (blend) | 30% diblock Ex 1 | 61 | 173 | 105 | 98 | — | −8.7 | 21.4 | −3.8 |
| | 70% HomoPLLA | | | | | | (70%) | | (30%) |
| Ex 5 (blend) | 10% diblock Ex 1 | 62 | 172 | 111 | — | — | −12.5 | 17.9 | — |
| | 90% HomoPLLA | | | | | | (100%) | | |
| Ex 6 (blend) | 50% diblock Ex 2 | 60 | 172 | 99 | 95 | — | −7.5 | 19.2 | −2.9 |
| | 50% HomoPLLA | | | | | | (72%) | (20.0) | (28%) |

The results displayed in Table 5 show that blending a diblock PTMC-b-PLLA with an homoPLLA can enhance the crystallisation of the latter homopolymer. The efficiency of this process is more noticeable at a 50 wt-% loading of the diblock copolymer (example 3). Lower loadings of 30 wt-% and 10 wt-% lead to partial or no nucleating effect. More, the efficiency of the nucleating process also depends on the type of diblock copolymer PTMC-b-PLLA used as can be seen by comparing examples 3 and 6.

1. A method for accelerating the crystallisation of poly(L- or D-lactide)s consisting in adding a polycarbonate block either as co-initiator and transfer agent in the copolymerisation of a lactide and a cyclic carbonate, or as the polycarbonate block in a blend, carbonate/lactide block copolymer/polylactide, wherein the amount of polycarbonate is of at most 30 wt %, based on the weight of the final copolymer, and characterised in that nucleation is provided by the polycarbonate block.

2. The method of claim 1 wherein the lactide is L-lactide.

3. Then method of claim 1 wherein the lactide monomer is copolymerised in the presence of one or more of the catalyst systems and a linear monohydroxy HO—PC—OR, or a linear dihydroxy telechelic HO—PC—OH, or a star polyhydroxy R—(PC—OH)n end-capped polycarbonate acting both as co-initiator and as transfer agent via hydroxyl group(s), and wherein PC is a polycarbonate chain obtained by immortal ring-opening polymerisation of a cyclic carbonate monomer and wherein the polycarbonate block (chain) acts as nucleating agent.

4. The method of claim 1 wherein a homopolylactide and a polycarbonate, prepared by immortal ring opening polymerisation, are blended, and wherein the polycarbonate blended with the polylactide is under the form of a lactide/carbonate block copolymer.

5. The method of claim 1 wherein the multi-block lactide/carbonate (co)polymers are prepared by immortal ring-opening polymerisation that comprises the steps of:
a) providing catalyst system based on a compound selected from a Lewis acidic metal salt or a metal complex or a metal-free organic base;
b) providing either a linear monohydroxy HO—PC—OR, or a linear dihydroxy-telechelic HO—PC—OH, or a star polyhydroxy R—(PC—OH)n end-capped polycarbonate acting both as co-initiator and as transfer agent via hydroxyl group(s), wherein PC is a polycarbonate chain obtained by immortal ring-opening polymerisation of a cyclic carbonate monomer;
c) providing a lactide monomer;
d) maintaining under polymerisation conditions at a temperature of from room temperature to 150° C. in bulk (melted monomer) or in a solvent;
retrieving a di- tri- or multi-block copolymer.

6. The method claim 1 wherein the polycarbonate is polytrimethylenecarbonate (PTMC).

7. The method according to claim 1 wherein the amount of polycarbonate in the final copolymer ranges between 1 and 10 wt-% based on the total weight of the final polymer and preferably between 1 and 7 wt-%.

8. The method according to claim 1 wherein the polycarbonate block acting as nucleating agent is derived from biorenewable resources by ring opening polymerisation of cyclic carbonates.

9. Use of polycarbonate block added either as co-initiator and transfer agent in the copolymerisation of a lactide and a cyclic carbonate, or in a blend carbonate/lactide block copolymer/polylactide, according to claim 1, to increase the crystallisation rate of poly(L- or D-lactide)s while keeping the thermal and mechanical properties unchanged.
